(19) United States
(12) Patent Application Publication
(10) Pub. No.: US 2026/0050199 A1
(43) Pub. Date: Feb. 19, 2026

(54) Mitigating Photodegradation of Organic Electro-Optic Materials

(71) Applicant: Lightwave Logic, Inc., Englewood, CO (US)

(72) Inventors: Ginelle Ramann, Centennial, CO (US); Christoph Harder, Englewood, CO (US)

(73) Assignee: Lightwave Logic, Inc., Englewood, CO (US)

(21) Appl. No.: 19/300,182

(22) Filed: Aug. 14, 2025

Related U.S. Application Data
(60) Provisional application No. 63/683,985, filed on Aug. 16, 2024.

(51) Int. Cl. G02F 1/361; G02F 1/365

(52) U.S. Cl. CPC G02F 1/3615; G02F 1/3611; G02F 1/3612; G02F 1/365; G02F 2202/021; G02F 2202/022; G02F 2202/06

(57) ABSTRACT

The present disclosure is directed, in general, to electro-optic (EO) devices comprising: a substrate layer; an EO material layer deposited on at least a portion of the substrate layer, where the EO material layer comprises a polymer host material and a non-linear optic chromophore guest material; and an oxygen barrier layer encasing at least a portion of the EO material layer.

### CROSS REFERENCE TO RELATED APPLICATIONS

This application claims the benefit of U.S. Provisional Application Patent Application No. 63/683,985, filed on Aug. 16, 2024. U.S. Provisional Application No. 63/683,985 is incorporated herein by reference in its entirety.

### BACKGROUND

The rise of silicon photonics has led to renewed interest in the use of electro-optic (EO) materials in next generation device applications. Materials with a strong EO response and high-speed phase modulation in thin film form are essential for low power and small footprint devices, including devices used in data acquisition systems, analog I/O modules, field transmitters, lab and field instrumentation, servo drive control modules, direct current (DC) power supply, alternating current (AC), and/or electronic load.

EO materials generally fall into three categories: (1) liquid crystals, including ferroelectric liquid crystals, and/or organic liquid crystals having a linear structure with a central core that contains several collinear rings, a linear unsaturated linkage and two terminal chains, and the like; (2) inorganic crystals characterized by a lack of inversion symmetry, such as KH₂PO₄ (KDP), KD₂PO₄ (KD*P or DKDP), lithium niobate (LiNbO₃), beta-barium borate (BBO), and barium titanate (BTO), and (3) EO polymers, including non-linear optic (NLO) chromophore-polymer composite materials.

EO materials containing liquid crystals generally have desirable EO coefficient but exhibit inherently low phase modulation speeds due to the parasitic effect of the crystal metastructure. Conversely, EO materials containing lithium niobate and/or other inorganic crystals generally achieve desirable modulation speeds, but their EO effects are inherently limited by optically active point defects invariably formed in the crystals during growth.

NLO chromophore-polymer composite materials can provide both high EO coefficient and high modulation speeds. The photostability is one of the most useful properties of the chromophores. High photostability, for example, ensures that chromophores will not degrade under illumination in an air atmosphere. The degradation of chromophores under illumination in the air will happen if double bonds in the chromophores react with molecular oxygen. Generally, the molecular oxygen in the air atmosphere can be either triplet oxygen or singlet oxygen. Triplet oxygen is the electronic ground state of molecular oxygen, which means triplet oxygen is the most stable and common allotrope of oxygen and is not reactive toward the double bonds found in chromophores. However, light converts triplet oxygen molecules to singlet oxygen molecules, which are very reactive toward those double bonds. In summary, singlet oxygen is the reason the chromophores will degrade under illumination in the air atmosphere. The reaction of singlet oxygen with the double bonds of chromophores will deactivate the chromophores by rendering the double bonds optically inactive.

Chromophores that are shielded from and/or resistant to the degradation by singlet oxygen are highly useful for implementation in a number of electro-optic device applications from an operability standpoint. Such chromophores are also economically advantageous in that less resources must be spent on excluding oxygen from a working EO device. Thus, there is a need in the art for improved photostability of chromophores.

### BRIEF SUMMARY

In some aspects, the disclosure concerns electro-optic (EO) devices comprising: a substrate layer; an EO material layer deposited on at least a portion of the substrate layer, where the EO material layer comprises a polymer host material and a non-linear optic chromophore guest material; and an oxygen barrier layer encasing at least a portion of the EO material layer.

In another aspect, the disclosure concerns electro-optic (EO) devices comprising: (i) a substrate; and (ii) an EO material layer deposited on at least a portion of the substrate layer, where the EO material layer comprises a polymer host material and a non-linear optic chromophore guest material; wherein the EO material layer has a getter compound dispersed with the layer of EO material as a second guest material.

In some embodiments, the getter compound is an organic compound. Organic getter compounds include, but are not limited to, carotenoids or 1,4-diazabicyclo[2.2.2]octane (DABCO).

In other embodiments, the getter compound is an inorganic compound. Inorganic getter compounds include, but are not limited to, aluminum, silicon, or yttrium elements.

Some embodiments comprising a substrate and EO material layers additionally comprise an oxygen barrier layer, wherein the oxygen barrier layer oxygen barrier layer encases at least a portion of the EO material layer.

It should be noted that it is contemplated that each of the elements above may be combined with any other elements.

### BRIEF DESCRIPTION OF SEVERAL VIEWS OF THE DRAWINGS

The foregoing summary, as well as the following detailed description of preferred embodiments of the disclosure, will be better understood when read in conjunction with the appended drawings. The embodiments of the drawings are shown for illustration. It should be understood, however, that the disclosure is not limited to the precise arrangements and instrumentalities shown.

In the drawings:

FIG. 1 depicts an end view of an electro-optic (EO) polymer active region in a waveguide.

FIG. 2A depicts an example structure on using small molecule organic compounds to quench singlet oxygen.

FIG. 2B depicts an example structure on using inorganic dopants to quench triplet oxygen.

### DETAILED DESCRIPTION

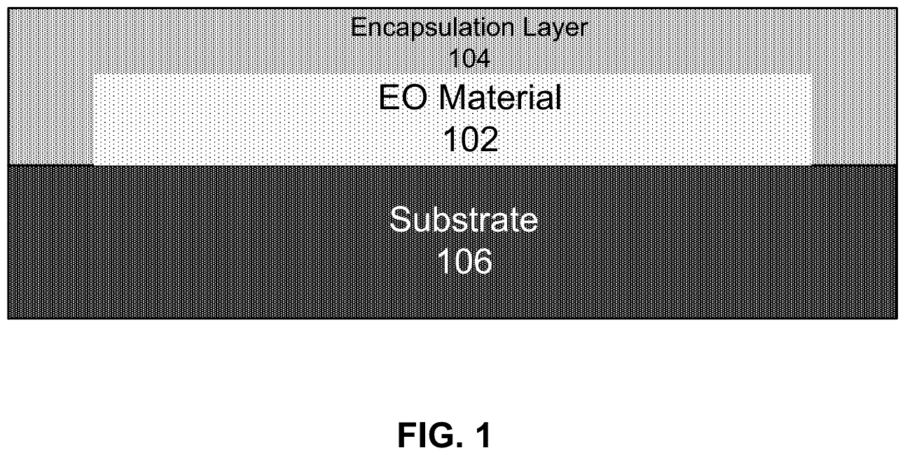

The present disclosure is directed, in general, to mitigation of light/singlet oxygen-based chromophore degradation. In various embodiments described herein, methods for mitigating light/singlet oxygen-based chromophore degradation include sterically hindered structures, structures with sacrificial moieties to quench O₂, use of getter compounds to quench O₂, and use of an encapsulation or oxygen barrier layer to prevent O₂ from reaching the electro-optic (EO) material layer. FIG. 1 depicts an end view of an EO polymer active region in a waveguide. An EO material layer 102 is covered by an encapsulation layer 104 which prevents oxygen from reaching the EO material layer 102. Meanwhile, the EO material layer 102 is above a substrate 106. The substrate 106 may include an oxide substrate and/or a silicon substrate. Not pictured in FIG. 1 is that the EO polymer active region, in some embodiments, may surround a wave guide structure.

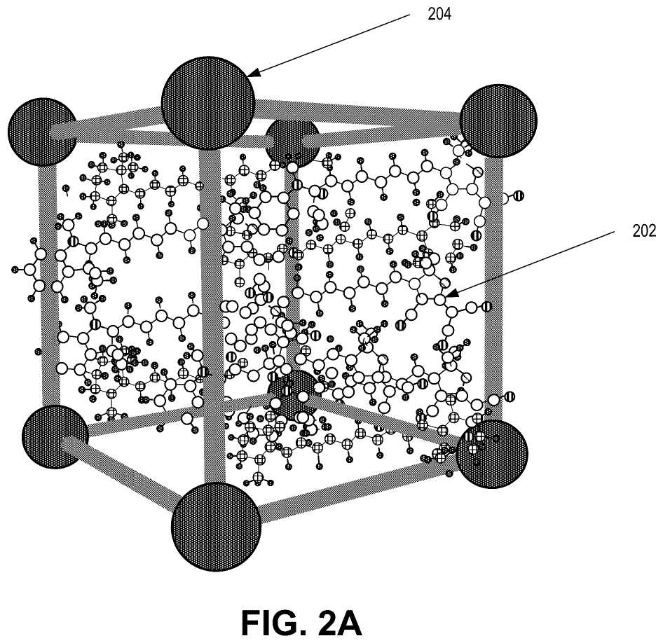

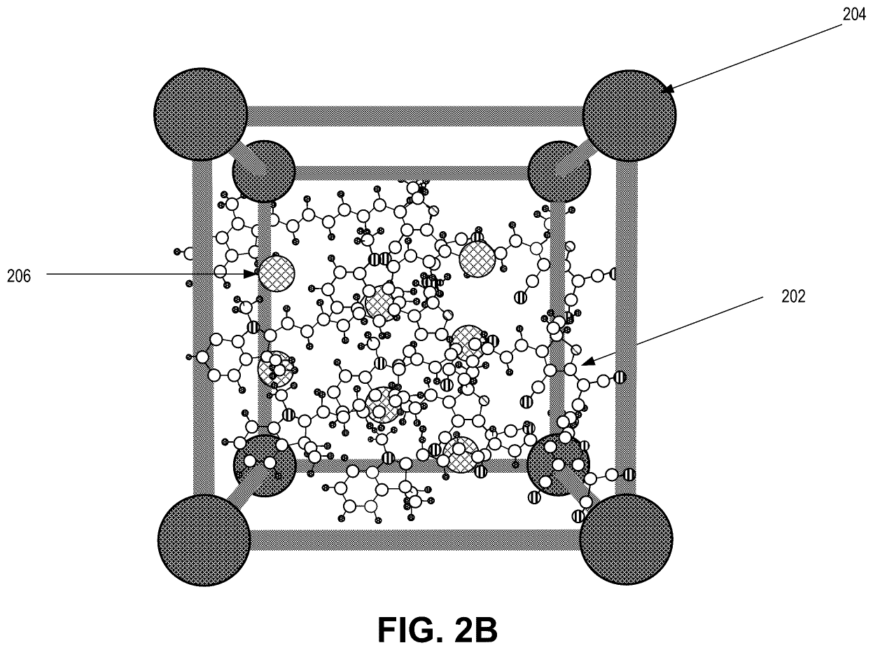

Getter compounds are used to quench singlet or triplet oxygen when interspersed in organic electric-optic (OEO) material. In various embodiments described herein, getter compounds are small molecule organic compounds to quench singlet oxygen. Examples of small molecule organic compounds include but are not limited to carotenoids (e.g., lycopene, beta-carotene) and triethylenediamine (DABCO). Material properties, degradation products, exothermic reactions, conductivity of the getter must be taken into consideration when selecting a getter for use. FIG. 2A depicts an example structure on using small molecule organic compounds to quench singlet oxygen. Small molecule organics 202 are interspersed in OEO material 204 to quench singlet oxygen.

In various embodiments described herein, getter compounds are inorganic dopants to quench triplet oxygen. Such inorganic dopants include, but are not limited to aluminum (Al), yttrium (Yt), or silicon (Si). These inorganic dopants are compatible with organic material. Further, the dopants are not conductive. The dopant reaction with triplet oxygen must not be exothermic. FIG. 2B depicts an example structure on using inorganic dopants to quench triplet oxygen. Inorganic dopants 206 are interspersed on OEO material 204 to quench triplet oxygen. In some embodiments, the getter quenches 102 and/or 302. One or more getter compounds may be used. As shown in FIG. 2B, Organic getters (e.g., small molecule organic compounds) 202 and inorganic getters (e.g., inorganic dopants) 206 may be used separately or in combination.

In some aspects, the disclosure concerns EO devices comprising: a substrate layer; an EO material layer deposited on at least a portion of the substrate layer, where the EO material layer comprises a polymer host material and a non-linear optic chromophore guest material; and an oxygen barrier layer encasing at least a portion of the EO material layer.

In another aspect, the disclosure concerns electro-optic (EO) devices comprising: (i) a substrate; and (ii) an EO material layer deposited on at least a portion of the substrate layer, where the EO material layer comprises a polymer host material and a non-linear optic chromophore guest material; wherein the EO material layer has a getter compound dispersed with the layer of EO material as a second guest material.

In some embodiments, the getter compound is an organic compound. Organic getter compounds include carotenoids or 1,4-diazabicyclo[2.2.2]octane (DABCO).

In other embodiments, the getter compound is an inorganic compound. Inorganic getter compounds include aluminum, silicon, or yttrium compounds.

Some embodiments comprising a substrate and EO material layers additionally comprise an oxygen barrier layer, wherein the oxygen barrier layer oxygen barrier layer encases at least a portion of the EO material layer.

In some embodiments, the EO material of the disclosure may surround a wave guide structure.

It should be noted that it is contemplated that each of the elements above may be combined with any other elements.

The EO material layer may include a nonlinear optical chromophore and one or more matrix material, also referred to as host polymer. Nonlinear optical chromophores in accordance with the various embodiments of the disclosure have the general formula (I):

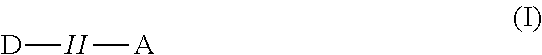

wherein D represents an organic electron-donating group; A represents an organic electron-accepting group having an electron affinity greater than the electron affinity of D; and Π represents a Π-bridge between A and D. The terms electron-donating group (donor or “D”), Π-bridge (bridging group or “Π”), and electron-accepting group (acceptor or “A”), and general synthetic methods for forming D-Π-A chromophores are well known in the art.

A donor is an atom or group of atoms that has a low oxidation potential, wherein the atom or group of atoms can donate electrons to an acceptor through a Π-bridge. The donor (D) has a lower electron affinity than the acceptor (A), so that, at least in the absence of an external electric field, the chromophore is generally polarized, with relatively less electron density on the donor (D). Typically, a donor group contains at least one heteroatom that has a lone pair of electrons capable of being in conjugation with the p-orbitals of an atom directly attached to the heteroatom such that a resonance structure can be drawn that moves the lone pair of electrons into a bond with the p-orbital of the atom directly attached to the heteroatom to formally increase the multiplicity of the bond between the heteroatom and the atom directly attached to the heteroatom (i.e., a single bond is formally converted to double bond, or a double bond is formally converted to a triple bond) so that the heteroatom gains formal positive charge. The p-orbitals of the atom directly attached to the heteroatom may be vacant or part of a multiple bond to another atom other than the heteroatom. The heteroatom may be a substituent of an atom that has π bonds or may be in a heterocyclic ring. Exemplary donor groups include but are not limited to R₂N— and RₙX¹—, where R is alkyl, aryl or heteroaryl, X¹ is O, S, P, Se, or Te, and n is 1 or 2. The donor group may be substituted further with alkyl, aryl, or heteroaryl.

In some embodiments of the present disclosure, D can represent any organic electron donating group, so long as D is bound to the Π-bridge at two atomic positions on the Π-bridge other than the two atomic positions at which A is bound to the Π-bridge such that at least a portion of D forms a ring fused to the Π-bridge.

Examples of organic electron donating groups suitable for incorporation into the chromophores of Formula (I) include, but are not limited to, the following structures, wherein the dashed lines represent the two atomic positions at which D forms a ring fused to the Π-bridge:

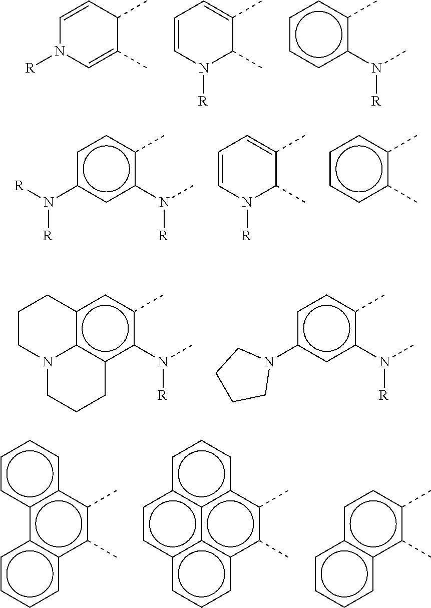

wherein each R independently represents a pendant spacer group.

An acceptor is an atom or group of atoms that has a low reductive potential, wherein the atom or group of atoms can accept electrons from a donor through a Π-bridge. The acceptor (A) has a higher electron affinity than the donor (D), so that, at least in the absence of an external electric field, the chromophore is generally polarized in the ground state, with relatively more electron density on the acceptor (D). Typically, an acceptor group contains at least one electronegative heteroatom that is part of a π bond (a double or triple bond) such that a resonance structure can be drawn that moves the electron pair of the x bond to the heteroatom and concomitantly decreases the multiplicity of the π bond (i.e., a double bond is formally converted to single bond or a triple bond is formally converted to a double bond) so that the heteroatom gains formal negative charge. The heteroatom may be part of a heterocyclic ring. Exemplary acceptor groups include but are not limited to —NO₂, —CN, —CHO, COR, CO₂R, —PO(OR)₃, —SOR, —SO₂R, and —SO₃R where R is alkyl, aryl, or heteroaryl. The acceptor group may be substituted further with alkyl, aryl, and/or heteroaryl.

In various nonlinear optical chromophores in accordance with various embodiments of the present disclosure, suitable electron-accepting groups include those according to general formula (Va):

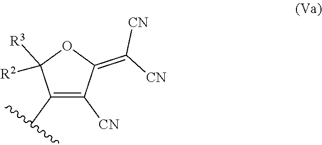

wherein R² and R³ each independently represents a moiety selected from the group consisting of H, substituted or unsubstituted C₁-C₁₀ alkyl, substituted or unsubstituted C₂-C₁₀ alkenyl, substituted or unsubstituted C₂-C₁₀ alkynyl, substituted or unsubstituted aryl, substituted or unsubstituted alkylaryl, substituted or unsubstituted carbocyclic, substituted or unsubstituted heterocyclic, substituted or unsubstituted cyclohexyl, and (CH₂)ₙ—O(CH₂), where n is 1-10.

A “Π-bridge” includes an atom or group of atoms through which electrons may be delocalized from an electron donor (defined above) to an electron acceptor (defined above). Typically, the orbitals of a Π-bridge will be p-orbitals on double (sp²) or triple (sp) bonded carbon atoms such as those found in alkenes, alkynes, neutral or charged aromatic rings, and neutral or charged heteroaromatic ring systems. Additionally, the orbitals may be p-orbitals on atoms such as boron or nitrogen. Further, the orbitals may be p, d or f organometallic orbitals or hybrid organometallic orbitals. The atoms of the bridge that contain the orbitals through which the electrons are delocalized are referred to here as the “critical atoms.” In some embodiments, the number of critical atoms in a bridge may be a number from 1 to about 30. The critical atoms may be substituted with an organic or inorganic group. The substituent may be selected with a view to improving the solubility of the chromophore in a polymer matrix, to enhance the stability of the chromophore, or for other purposes.

Π may represent a fused, offset, polycyclic, optionally heteroatom-containing, pi-conjugated core. Core structures in accordance with the various embodiments of the present disclosure are “pi-conjugated” meaning that the core structure contains at least two double bonds separated by a single bond, and preferably more than two double bonds each separated by a single bond. Core structures in accordance with the various embodiments of the present disclosure are polycyclic and fused, meaning that the core structure contains at least two rings which share two atoms between the two rings.

Suitable bridges (Π) for nonlinear optical chromophores according to the various embodiments of the present disclosure are organic moieties containing charge transporting groups and having at least one end capable of bonding to a D group and at least one end capable of bonding to an A group and include those described in the previously incorporated references. Suitable charge-transporting groups include, for example, arylamines, in particular triarylamines; and heteroaromatics, including fused and oligomeric heteroaromatics such as oligothiophene or fused thiophenes, as well as phthalocyanine-based compounds, porphyrin-based compounds, azobenzene-based compounds, benzidine-based compounds, arylalkane-based compounds, aryl-substituted ethylene-based compounds, stilbene-based compounds, anthracene-based compounds, hydrazone-based compounds, quinone-based compounds, and fluorenone-based compounds.

Examples of chromophores with general formula (I) may include the following chromophores:

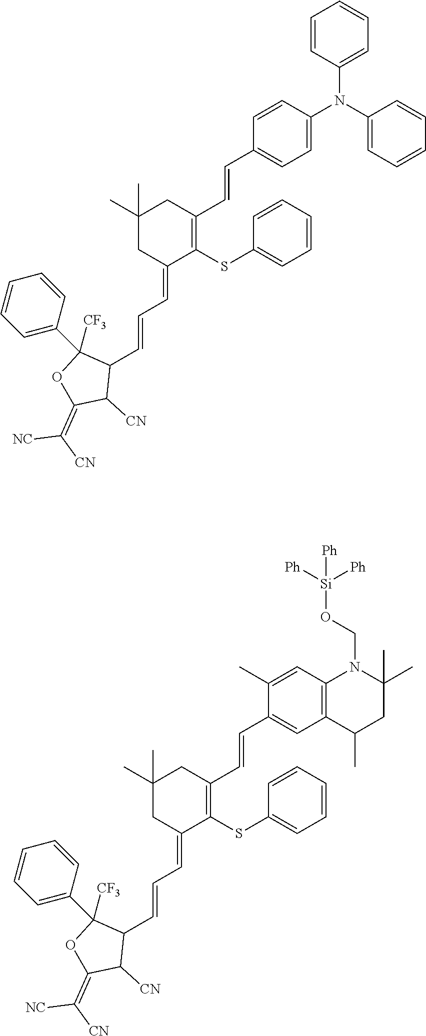

In some embodiments, a sterically hindered non-linear chromophores show good photostability and oxygen resistance.

Suitable host polymers into which a nonlinear optical chromophore according to any of the various embodiments of the disclosure may be incorporated include amorphous polymers, such as, for example: polyetherimides (PEI); poly(methylmethacrylate) s (PMMA); polyimides; polyamic acid; polystyrenes; poly(urethane) s (PU); and amorphous polycarbonates (APC). In various embodiments the host polymer comprises a polyetherimide. Preferred amorphous host polymers have high T_{g} values, low optical loss and good adhesion. The nonlinear optical chromophores are generally incorporated within the host polymer at a loading of 1% to 99% by weight, based on the entire nonlinear optical material and, more particularly, at a loading of 5% to 50% by weight.

A non-linear optic chromophore guest material is a material comprising a non-linear optic (NLO) chromophore-polymer composite material disclosed herein.

A substrate or substrate layer is a support structure for the EO material. Such structures are generally non-conductive, particularly in waveguide applications. In some embodiments, the structure comprises SiO₂.

As used herein, the following terms have the following meanings unless expressly stated to the contrary.

As used herein, the term “about”, in the context of concentrations of components of the formulations or in property values, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

When values are expressed as approximations, by use of the antecedent “about,” it will be understood that the particular value forms another example.

All ranges are inclusive and combinable. In addition, when a range is recited, it is contemplated that all values within the range, including end points, are combinable in all possible combinations.

As used herein, the term “wt %” refers to weight percentage. The weight percentage of a component equals a ratio of a mass of a component to the total mass of the whole compound or product.

As used herein, the singular forms “a,” “an,” and “the” and similar referents in the context of describing the elements (especially in the context of the following claims) include plural references unless the context clearly dictates otherwise. For example, reference to “a substituent” encompasses a single substituent as well as two or more substituents, and the like. It is understood that any term in the singular may include its plural counterpart and vice versa, unless otherwise indicated herein or clearly contradicted by context.

Any use of section headings is intended to aid reading of the document and is not to be interpreted as limiting; information that is relevant to a section heading may occur within or outside of that particular section.

As used herein, the terms “for example,” “for instance,” “such as,” or “including” are meant to introduce examples that further clarify more general subject matter.

As used herein, the term “electron-donating group” refers to an atom and/or a functional group that donates some of its electron density into a conjugated II system via resonance and/or inductive effects.

As used herein, the term “electron-accepting group” refers to an atom and/or a functional group that accepts some of the electron-donating group's electron density in a conjugated II system via resonance and/or inductive effects.

As used herein, the term “bridging group” refers to a functional group that bridges between the electron-donating group and the electron-accepting group in a conjugated II system.

As used herein, the term “compositions” refers to one or more mixed composition(s) that may include both a nonlinear electro-optic material and solvents.

As used herein, the term “singlet oxygen” and/or “¹O₂” refers to a highly reactive form of molecular oxygen in which all electrons are paired. The singlet oxygen is an excited state and is more reactive compared to oxygen molecules in ground state.

As used herein, the term “triplet oxygen” and/or “³O₂” refers to a stable form of molecular oxygen which has two unpaired electrons with parallel spins. The triplet oxygen is in ground state and is more stable compared to oxygen molecules in excited state

As used herein, the term “EO polymer active region” refers to a region in a waveguide which comprises an EO polymer layer and a substrate layer below the EO polymer layer. In some preferred examples, the EO polymer active region may include an encapsulation layer above the EO polymer layer.

As used herein, the term “getter compounds” refers to compounds that remove reactive gasses. For example, the reactive gas removed may be oxygen.

As used herein, the term “electro-optic devices” refers to devices with electro-optical function that contain one or more resistive layer(s) described above. For example, the electro-optic devices may include electro-optic modulators (EOMs), which are optical devices in which a signal-controlled element exhibiting an electro-optic effect is used to modulate a beam of light.

As used herein, the term “nonlinear optical chromophore” (NLO Chromophore) refers to molecules or portions of a molecule that create a nonlinear electro-optic effect when irradiated with light. The chromophores are any molecular unit whose interaction with light gives rise to the nonlinear optical effect. The desired effect may occur at resonant or non-resonant wavelengths. The activity of a specific chromophore in a nonlinear electro-optic material is stated as its electro-optic coefficient (r₃₃), which is related to the molecular dipole moment and hyperpolarizability. The various embodiments of NLO chromophores of the present disclosure are useful structures for the production of NLO effects.

As used herein, the terms “triethylenediamine”, “DABCO”, and “1,4-diazabicyclo[2.2.2]octane” refer to the same chemical having the following structure:

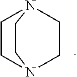

What is claimed:

1. An electro-optic (EO) device comprising:
a substrate layer;
an EO material layer deposited on at least a portion of the substrate layer, wherein the EO material layer comprises a polymer host material and a nonlinear optical chromophore guest material; and
an oxygen barrier layer encasing at least a portion of the EO material layer.

2. The electro-optic device of claim 1, wherein the EO material layer comprises a getter compound dispersed with the layer of EO material.

3. The electro-optic device of claim 2, wherein the getter compound is an organic compound.

4. The electro-optic device of claim 3, wherein the organic compound comprises a carotenoid or triethylenediamine.

5. The electro-optic device of claim 2, wherein the getter compound is an inorganic dopant.

6. The electro-optic device of claim 5, wherein the inorganic dopant comprises aluminum, silicon, or yttrium.

7. The electro-optic device of claim 1, wherein the nonlinear optical chromophore guest material comprises nonlinear optical chromophore, wherein the nonlinear optical chromophore has the general formula (I): 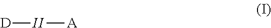
wherein D represents an organic electron-donating group; A represents an organic electron-accepting group having an electron affinity greater than the electron affinity of D; and Π represents a Π-bridge between A and D.

8. The electro-optic device of claim 7, wherein A represents an organic electron-accepting group of a general formula (Va): 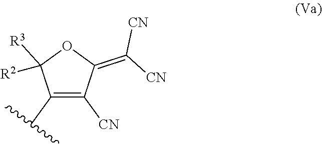
wherein R² and R³ each independently represents a moiety selected from the group consisting of H, substituted or unsubstituted C₁-C₁₀ alkyl, substituted or unsubstituted C₂-C₁₀ alkenyl, substituted or unsubstituted C₂-C₁₀ alkynyl, substituted or unsubstituted aryl, substituted or unsubstituted alkylaryl, substituted or unsubstituted carbocyclic, substituted or unsubstituted heterocyclic, substituted or unsubstituted cyclohexyl, and (CH₂)ₙ—O(CH₂), where n is 1-10.

9. The electro-optic device of claim 7, wherein the nonlinear optical chromophore is:

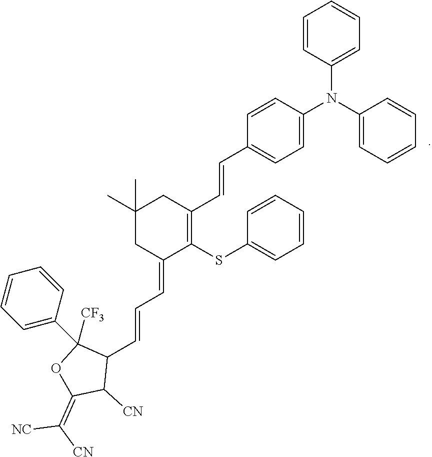 [SMILES: CC1(C)CC(/C=C/c2ccc(N(c3ccccc3)c3ccccc3)cc2)=C(Sc2ccccc2)C(=C/C=C/C2C(C#N)C(=C(C#N)C#N)OC2(c2ccccc2)C(F)(F)F)/C1]

10. The electro-optic device of claim 7, wherein the nonlinear optical chromophore is:

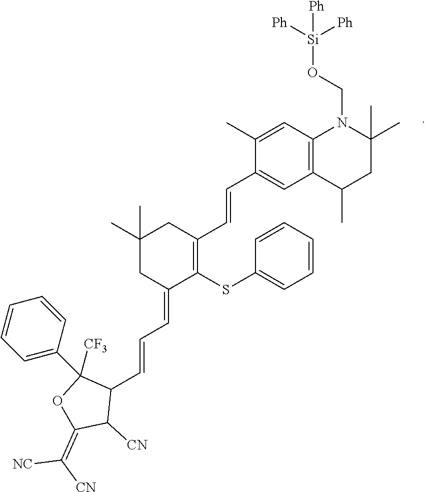 [SMILES: Cc1cc2c(cc1/C=C/C1=C(Sc3ccccc3)C(=C/C=C/C3C(C#N)C(=C(C#N)C#N)OC3(c3ccccc3)C(F)(F)F)/CC(C)(C)C1)C(C)CC(C)(C)N2CO[Si](c1ccccc1)(c1ccccc1)c1ccccc1]

11. The electro-optic device of claim 1, wherein the polymer host material comprises polyetherimides (PEI), poly(methylmethacrylate)s (PMMA), polyimides, polyamic acid, polystyrenes, poly(urethane)s (PU), or amorphous polycarbonates (APC).
